(19) United States
(12) Patent Application Publication
(10) Pub. No.: US 2011/0154993 A1
(43) Pub. Date: Jun. 30, 2011

(54) AUTOMATIC MACHINE FOR PRODUCING BEVERAGES

(75) Inventor: Andrea Bertolina, Montegrosso d'Asti (IT)

(73) Assignee: SGL Italia S.r.l. con Unico Socio, Torino (IT)

(21) Appl. No.: 12/993,414

(22) PCT Filed: May 19, 2009
(86) PCT No.: PCT/EP2009/056102

§ 371 Date: Mar. 10, 2011

(30) Foreign Application Priority Data
May 20, 2008 (IT) TO2008A 000375

(51) Int. Cl. A47J 31/40

(52) U.S. Cl. 99/280

(57) ABSTRACT

An automatic machine for producing beverages by percolating powdered material, the machine having a front wall; a window formed through the front wall to allow a user to load a measure of material; and a door fitted to the front wall to slide to and from a closed position closing the window.

### TECHNICAL FIELD

The present invention relates to an automatic machine for producing beverages by percolating powdered material.

### BACKGROUND ART

More specifically, the present invention relates to an automatic machine for producing beverages by percolating powdered material, and of the type comprising a front wall; a window formed through the front wall to allow the user to load a measure of material; and a door closing the window.

### DISCLOSURE OF INVENTION

It is an object of the present invention to provide a machine of the above type, which is highly compact, cheap and easy to manufacture, and provides for troublefree loading of the material.

According to the present invention, there is provided an automatic machine for producing beverages by percolating powdered material, as claimed in Claim 1 and preferably in any one of the following Claims depending directly or indirectly on Claim 1.

### BRIEF DESCRIPTION OF THE DRAWINGS

A non-limiting embodiment of the invention will be described by way of example with reference to the accompanying drawings, in which:

FIGS. 1 and 2 show front views of a preferred embodiment of the machine according to the present invention in respective different operating configurations;

FIG. 3 shows a larger-scale view in perspective of a detail in FIGS. 1 and 2;

FIG. 4 shows a larger-scale inside view of a detail in FIG. 1;

FIG. 5 shows a larger-scale inside view in perspective of a detail in FIG. 2.

### BEST MODE FOR CARRYING OUT THE INVENTION

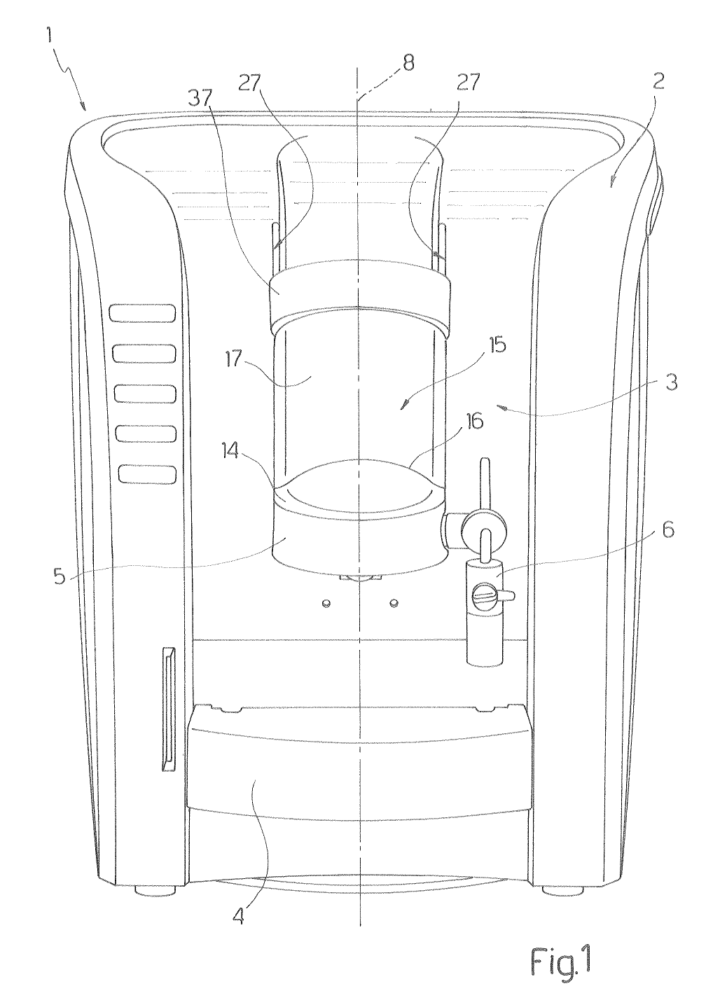

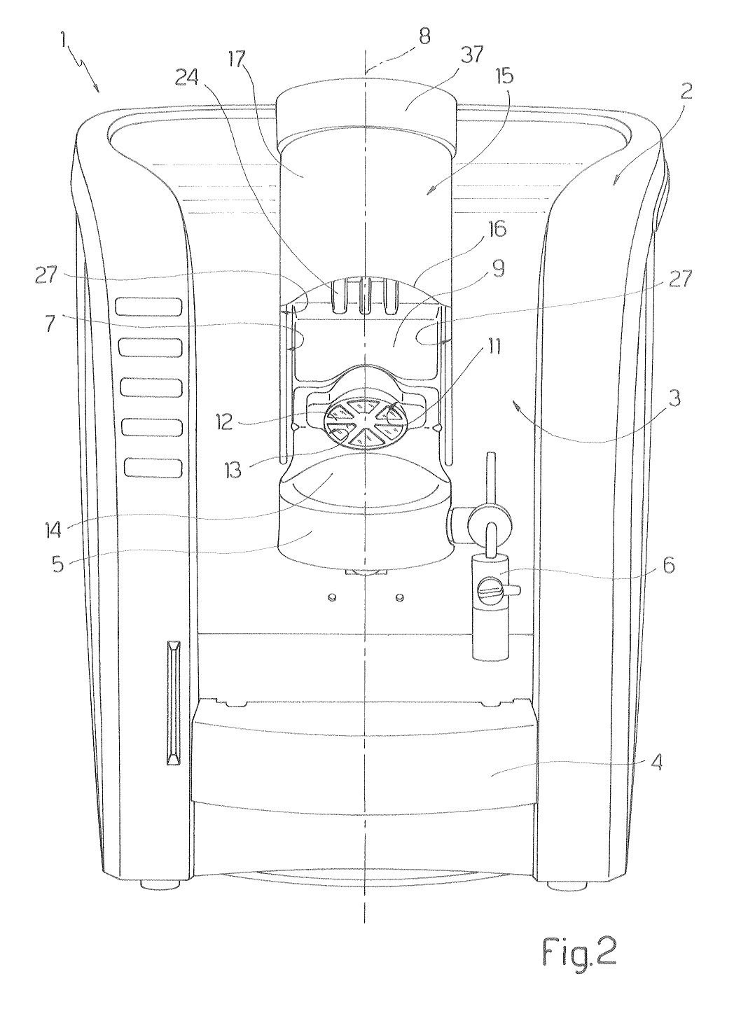

Number 1 in FIGS. 1 and 2 indicates as a whole an automatic machine for producing beverages—in this case, espresso coffee—by percolating powdered material.

Machine 1 comprises an outer casing 2 having a front wall 3, from which project outwards a support 4 for supporting a cup (not shown) for the beverage; and a dispenser assembly 5 having a steam dispensing device 6 and located over and a given distance from support 4.

Above dispenser assembly 5, front wall 3 has a substantially rectangular window 7 centred with respect to a vertical axis 8 of symmetry of front wall 3 and closed by a plate 9, which is fitted to an inner surface 10 of front wall 3 and has an opening 11 by which a measure of powdered material, contained in a capsule 12, is inserted from the outside into a percolating seat 13 (FIG. 2). Plate 9 comprises a lower body 14 projecting outwards through a bottom portion of window 7 and resting on dispenser assembly 5.

Window 7 and opening 11 are protected by a door 15 which slides, in a direction parallel to axis 8, between a lowered closed position (FIG. 1), in which an edge 16 of door 15 rests on a top edge of lower body 14 to prevent access to window 7 and, hence, opening 11, and a raised open position (FIG. 2) allowing access to opening 11 from the outside to load capsule 12 into seat 13.

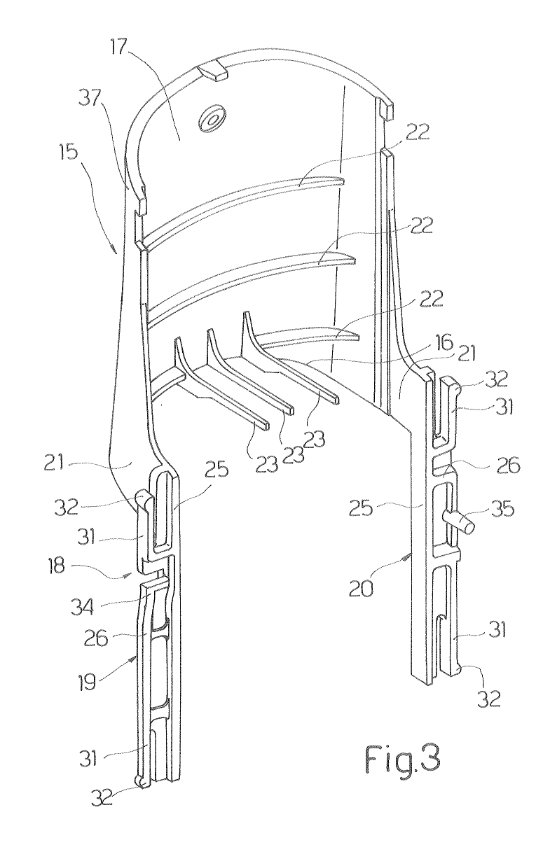

As shown more clearly in FIG. 3, door 15 has a substantially inverted-U-shaped structure, and comprises a central top cover portion 17, which constitutes the actual door 15 and is convex in shape with its concavity facing front wall 3; and a bottom guide portion 18. Bottom portion 18 comprises two skids 19 and 20, each of which extends downwards, in a direction parallel to axis 8, from the free end of a respective appendix 21 projecting, in a direction substantially perpendicular to front wall 3, from the bottom end of a respective lateral edge of top portion 17.

Top portion 17 is reinforced internally by a number of transverse ribs 22, and has, at edge 16, which is a bottom edge of top portion 17, a number of feeler fingers 23, which are perpendicular to front wall 3, extend through window 7, and engage in transversely sliding manner respective grooves 24 formed in a top portion of plate 9. Grooves 24 are axially open towards opening 11 to allow feeler fingers 23 to engage opening 11 when door 15 is in the lowered closed position. Fingers 23 are designed to interfere with capsule 12, in the event capsule 12 is not inserted properly inside seat 13, to prevent full closure of door 15 and, as explained below, startup of the operating cycle of machine 1.

Each skid 19, 20 in bottom portion 18 has an L-shaped cross section, and comprises a lateral shoulder 25 coplanar with respective appendix 21; and a lateral rib 26 projecting laterally outwards from respective shoulder 25 and lying in a plane perpendicular to the plane of respective shoulder 25.

Each appendix 21 engages in sliding manner a respective slot 27 parallel to axis 8 and formed through front wall 3, outwards of a respective lateral edge of window 7; and each skid 19, 20 engages a respective substantially tubular guide 28 extending along relative slot 27 and along the inner surface 10 of front wall 3.

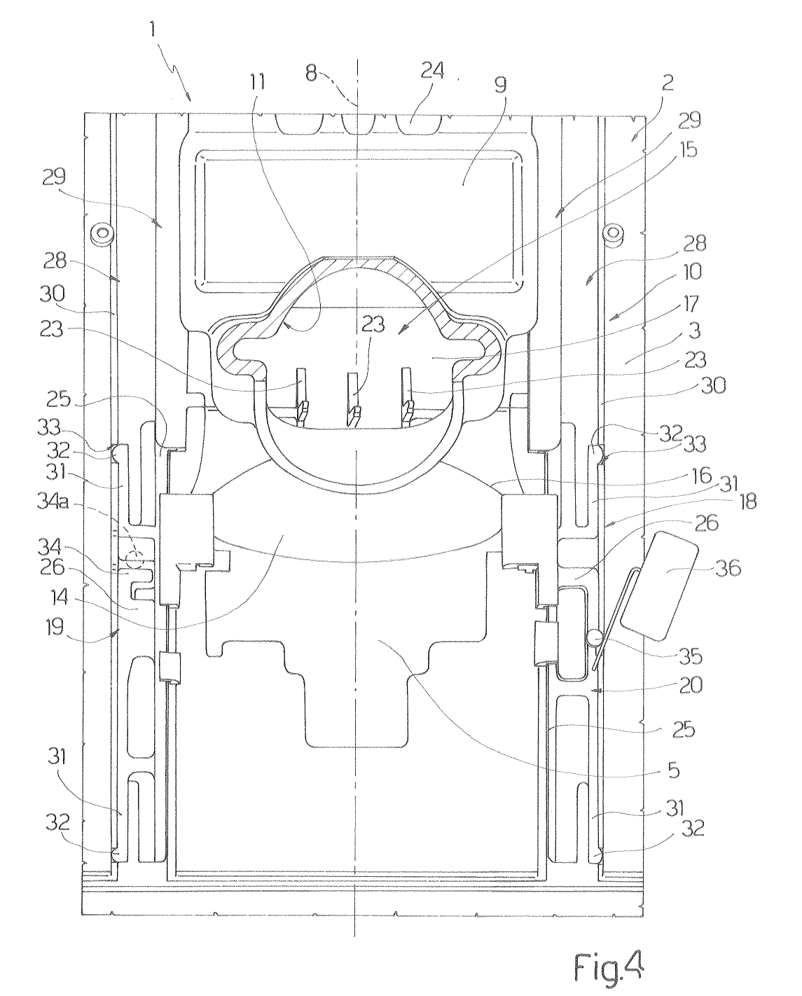

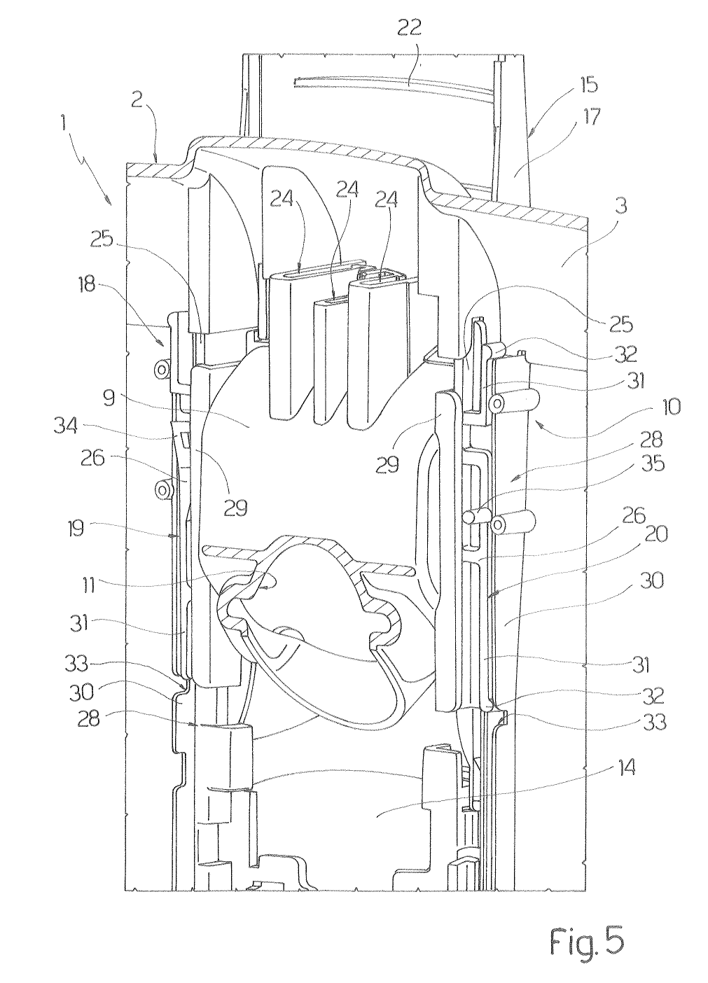

With reference to FIGS. 4 and 5, each guide 28 comprises a rear surface defined by inner surface 10; and an inner lateral wall and a front wall, which are defined by a respective L-section rib 29, a top portion of which is integral with plate 9, and a bottom portion of which is integral with front wall 3. Each guide 28 is also bounded laterally by a rib 30 opposite rib 29 and integral with front wall 3.

At each axial end, each rib 26 of each skid 19, 20 has an elastically deformable appendix 31, the free end of which has a laterally projecting catch 32 which, when door 15 is in the lowered closed position (FIG. 4), clicks inside a respective seat 33 in relative rib 30 to click and lock door 15 releasably into the lowered closed position. When door 15 is in the raised open position (FIG. 5), each top catch 32 clicks onto the top end of relative rib 30 to click and lock door releasably 15 into the raised open position.

Below its top appendix 31, rib 26 of skid 19 has a tab 34 bent towards the front wall of relative rib 29, and which, when door 15 is in the lowered closed position (FIG. 4), cooperates with a pin 34a to define, with pin 34a, a mechanical safety lock of door 15.

Rib 26 of skid 20 has a central pin 35 perpendicular to front wall 3, and which activates a microswitch 36 (FIG. 4) when door 15 is in the lowered closed position.

In actual use, door 15 is moved between the lowered closed position and the raised open position using an external handle 37 integral with door 15.

1) An automatic machine for producing beverages by percolating powdered material, the machine (1) comprising a front wall (3); a window (7) formed through the front wall (3) to allow a user to load a measure (12) of material; and a door (15) closing the window (7); the machine (1) being characterized by the door (15) being fitted to the front wall (3) to slide, in a given slide direction on the front wall (3), between an open position and a closed position opening and closing the window (7) respectively.

2) A machine as claimed in claim 1, wherein the slide direction is a substantially vertical direction.

3) A machine as claimed in claim 1 or 2, wherein the door (15) slides between a lowered closed position closing the window (7), and a raised open position opening the window (7).

4) A machine as claimed in one of claims 1 to 3, wherein the door (15) comprises a first position (17) located outside with respect to the front wall (3) and defining the actual door (15); and a second portion (18) located inside with respect to the front wall (3) and defining a guide device (28) of the door (15).

5) A machine as claimed in claim 4, wherein the door (15) comprises a third portion (21) connecting the first and second portion (17, 18); slot means (27) being formed through the front wall (3) to allow the third portion (21) to move with the first and second portion (17, 18) in the slide direction.

6) A machine as claimed in claim 4 or 5, wherein the first portion (17) comprises a handle (37) for operating the door (15).

7) A machine as claimed in one of claims 4 to 6, and comprising at least one guide (28) integral with the front wall (3) and parallel to the slide direction; the second portion (18) comprising a skid (19, 20) that engages the guide (28) in sliding manner.

8) A machine as claimed in claim 7, wherein the guide (28) extends along an inner surface (10) of the front wall (3).

9) A machine as claimed in one of the foregoing claims, and comprising catch means (32) for clicking and locking the door (15) releasably into the open and closed positions.

10) A machine as claimed in one of the foregoing claims, and comprising feeler means (23) for preventing the door (15) from reaching the closed position in the event the measure (12) of material is not loaded properly.

11) A machine as claimed in claim 10, wherein the feeler means (23) are carried by the door (15) and extend through the window (7).

12) A machine as claimed in one of the foregoing claims, and comprising control means (35, 36) for determining the position of the door (15) and for only allowing startup of an operating cycle of the machine (1) when the door (15) is in the closed position.

13) A machine as claimed in claim 12, wherein said control means comprise contrasting means (35) integral with the door (15); and a fixed switch (36) activated by the contrasting means when the door (15) is in the closed position.

14) A machine as claimed in one of the foregoing claims, and comprising catch means (34a) for locking the door (15) in the closed position during an operating cycle of the machine (1).
